(19) United States
(12) Patent Application Publication
(10) Pub. No.: US 2026/0269749 A1
(43) Pub. Date: Sep. 10, 2026

(54) MIDPOINT POTENTIAL BALANCING SYSTEM BASED ON MULTI-LEVEL MAGNETIC SUSPENSION BEARING DRIVER

(71) Applicants: HUAZHONG UNIVERSITY OF SCIENCE AND TECHNOLOGY, Hubei (CN); HUBEI SHUNYI TECHNOLOGY CO., LTD., Hubei (CN)

(72) Inventors: Jianfu DING, Hubei (CN); Dong JIANG, Hubei (CN); Zicheng LIU, Hubei (CN); Wenyi LI, Hubei (CN)

(73) Assignees: HUAZHONG UNIVERSITY OF SCIENCE AND TECHNOLOGY, Hubei (CN); HUBEI SHUNYI TECHNOLOGY CO., LTD., Hubei (CN)

(21) Appl. No.: 19/554,589

(22) Filed: Mar. 2, 2026

Related U.S. Application Data
(63) Continuation of application No. PCT/CN2025/102922, filed on Jun. 24, 2025.

(30) Foreign Application Priority Data
Mar. 6, 2025 (CN) 202510263767.1

(51) Int. Cl. H02N 15/00

(52) U.S. Cl. CPC H02N 15/00

(57) ABSTRACT

Disclosed is a midpoint potential balancing system based on a multi-level magnetic suspension bearing driver. The system includes: a three-level four-bridge arm driver including a switch bridge arm module and a capacitor bridge arm module connected in parallel, for acquiring winding current data, regulating the voltage of the switch bridge arm module to balance the midpoint potential of the capacitor bridge arm module; a current controller, for obtaining the average voltage of the switch bridge arm module; a midpoint voltage balancing module, communicatively connected to the current controller, for obtaining the zero-sequence voltage; a duty update module, communicatively connected to the midpoint voltage balancing module, for obtaining the switching time based on the zero-sequence voltage and the average voltage of the switch bridge arm module; a modulate module, communicatively connected to the duty update module, for receiving the switching time, and obtaining the voltage control signal.

### CROSS-REFERENCE TO RELATED APPLICATION

This application is a continuation of international PCT application serial no. PCT/CN2025/102922, filed on Jun. 24, 2025, which claims the priority benefit of China application serial no. 202510263767.1, filed on Mar. 6, 2025. The entirety of each of the above-mentioned patent application is hereby incorporated by reference herein and made a part of this specification.

### BACKGROUND

### Technical Field

The present disclosure relates to the technical field of magnetic suspension bearing control, and specifically relates to a midpoint potential balancing system based on a multi-level magnetic suspension bearing driver.

### Description of Related Art

As early as the 1940s, global scholars conducted in-depth research on magnetic suspension bearings. Magnetic suspension bearings are devices that utilize electromagnetic forces to suspend rotors, enabling non-contact operation between rotors and stators. This design eliminates mechanical contact between rotors and stators, thereby eliminating the need for lubrication, enhancing stability, extending operational lifespan, and preventing pollution. Magnetic suspension bearings have gradually replaced conventional mechanical bearings and are typically applied in technological fields such as energy storage flywheels and aerospace equipment high-speed motors, and precision machining tools.

A magnetic suspension bearing system may be constituted through components such as rotors, sensors, controllers, and electromagnetic actuators. The control system of the magnetic suspension bearing determines the overall performance of the device. Generally, this is achieved by converting the control signals into current within the windings through a power amplifier, thereby controlling the electromagnetic force of the magnetic bearing. The power amplifier is an essential component of the magnetic suspension bearing system.

Currently, the power amplifiers for magnetic suspension bearings predominantly utilize two-level configurations. However, as the power ratings of magnetic bearing systems increase, the issue of electromagnetic interference (EMI) within the system becomes increasingly prominent. The electromagnetic interference generated by the power amplifiers may adversely affect the suspension precision and reliability of the magnetic suspension bearings, which may result in an imbalance of the midpoint potential of the magnetic suspension bearing drivers. This imbalance is primarily due to the fact that the electromagnetic interference from the power amplifiers impacts the switching process of the magnetic suspension bearings and may also be coupled through the rotor into the position sensors of the magnetic bearings.

### SUMMARY

In view of this, it is necessary to provide a midpoint potential balancing system based on a multi-level magnetic suspension bearing driver to address the technical issue of midpoint potential imbalance. This imbalance is caused by the reduction in suspension accuracy and reliability of the magnetic suspension bearing driver due to electromagnetic interference generated by power amplifiers in the existing technology.

To address the aforementioned technical issues, the first aspect of the present disclosure provides a midpoint potential balancing system based on a multi-level magnetic suspension bearing driver, including:

A three-level four-bridge arm driver, including a switch bridge arm module and a capacitor bridge arm module connected in parallel, and provided to acquire winding current sampling data, and regulate a voltage of the switch bridge arm module based on a voltage control signal to balance a midpoint potential of the capacitor bridge arm module;

A current controller, configured to receive the winding current sampling data, and obtain an average voltage of the switch bridge arm module based on the winding current sampling data;

A midpoint voltage balancing module, communicatively connected to the current controller, and configured to obtain a zero-sequence voltage based on the average voltage of the switch bridge arm module;

A duty update module, communicatively connected to the midpoint voltage balancing module, and configured to receive the zero-sequence voltage and the average voltage of the switch bridge arm module, and obtain a switching time based on the zero-sequence voltage and the average voltage of the switch bridge arm module;

A modulation module, communicatively connected to the duty update module, and configured to receive the switching time, and obtain the voltage control signal based on the switching time.

In a possible implementation, the switch bridge arm module includes: four half-bridge arms and four winding units;

A first half-bridge arm is electrically connected to one end of a first winding unit;

A second half-bridge arm is electrically connected to one end of a second winding unit;

A third half-bridge arm is electrically connected to one end of a third winding unit;

A fourth half-bridge arm is electrically connected to one end of a fourth winding unit;

The other end of the first winding unit is electrically connected to the other end of the second winding unit, the other end of the third winding unit, and the other end of the fourth winding unit.

In a possible implementation, the first half-bridge arm includes: a first switch device, a first unidirectional conduction device, a second switch device, and a second unidirectional conduction device;

One end of the first switch device is electrically connected to one end of the second switch device and one end of the first unidirectional conduction device;

The other end of the second switch device is electrically connected to one end of the second unidirectional conduction device.

In a possible implementation, the second half-bridge arm includes: a third switch device, a third unidirectional conduction device, a fourth switch device, and a fourth unidirectional conduction device;

One end of the third switch device is electrically connected to one end of the fourth switch device and one end of the third unidirectional conduction device;

The other end of the fourth switch device is electrically connected to one end of the fourth unidirectional conduction device.

In a possible implementation, the third half-bridge arm includes: a fifth switch device, a fifth unidirectional conduction device, a sixth switch device, and a sixth unidirectional conduction device;

One end of the fifth unidirectional conduction device is electrically connected to one end of the fifth switch device;

The other end of the fifth switch device is electrically connected to one end of the sixth switch device and one end of the sixth unidirectional conduction device.

In a possible implementation, the fourth half-bridge arm includes: a seventh switch device, a seventh unidirectional conduction device, an eighth switch device, and an eighth unidirectional conduction device;

One end of the seventh unidirectional conduction device is electrically connected to one end of the seventh switch device;

The other end of the seventh switch device is electrically connected to one end of the eighth switch device and one end of the eighth unidirectional conduction device.

In a possible implementation, the capacitor bridge arm module includes: a first capacitor and a second capacitor;

One end of the first capacitor is electrically connected to the first switch device, the third switch device, the fifth unidirectional conduction device, and the seventh unidirectional conduction device, the other end of the first capacitor is electrically connected to one end of the second capacitor, the other end of the first unidirectional conduction device, the other end of the third unidirectional conduction device, the other end of the sixth unidirectional conduction device, and the other end of the eighth unidirectional conduction device, and the other end of the second capacitor is electrically connected to the other end of the second unidirectional conduction device, the other end of the fourth unidirectional conduction device, the other end of the sixth switch device, and the other end of the eighth switch device.

In a possible implementation, the system further includes: a sampling module, communicatively connected to the three-level four-bridge arm driver, for acquiring the winding current sampling data.

In a possible implementation, the system further includes: a drive circuit, electrically connected to the modulation module, for receiving the voltage control signal generated by the modulation module, and generating a drive signal based on the voltage control signal;

The three-level four-bridge arm driver is further electrically connected to the drive circuit, for receiving the drive signal, and regulating a voltage of the switch bridge arm module based on the drive signal to balance a midpoint potential of a driver.

In a second aspect, the present disclosure further provides a midpoint potential balancing method based on a multi-level magnetic suspension bearing driver, the method includes:

Acquiring winding current sampling data through a three-level four-bridge arm driver;

Obtaining an average voltage of a switch bridge arm module based on the winding current sampling data through a current controller;

Obtaining a zero-sequence voltage based on the average voltage of the switch bridge arm module through a midpoint voltage balancing module;

Obtaining a switching time based on the zero-sequence voltage and the average voltage of the switch bridge arm module through a duty update module;

Obtaining a voltage control signal based on the switching time through a modulation module;

Regulating a voltage of the switch bridge arm module based on the voltage control signal through the three-level four-bridge arm driver to balance a midpoint potential of a capacitor bridge arm module.

The advantageous effects of the present disclosure are: the present disclosure provides a midpoint potential balancing system based on a multi-level magnetic suspension bearing driver. The system includes a three-level four-bridge arm driver, a current controller, a midpoint voltage balancing module, a duty update module and a modulation module. The three-level four-bridge arm driver further includes a switch bridge arm module and a capacitor bridge arm module. The present disclosure inventively provides the switch bridge arm module, and controls the switch bridge arm module through a voltage control signal generated by the current controller, the midpoint voltage balancing module, the duty update module and the modulation module to achieve a three-level control effect, thereby increasing the number of steps for current conversion, reducing current harmonic, boosting the control on the three-level four-bridge arm driver, and thus achieving the midpoint potential balance of the capacitor bridge arm module.

### BRIEF DESCRIPTION OF THE DRAWINGS

In order to more clearly illustrate the technical solutions in the embodiments of the present disclosure, the accompanying drawings required for use in the description of the embodiments will be briefly introduced below. Clearly, the accompanying drawings in the following description are merely some embodiments of the present disclosure. For those skilled in the art, other drawings may also be obtained according to these drawings without inventive effort.

FIG. 1 is a system structure diagram of an embodiment of a midpoint potential balancing system based on a multi-level magnetic suspension bearing driver provided by the present disclosure.

FIG. 2 is a flowchart of a midpoint potential balancing method in an embodiment of a midpoint potential balancing system based on a multi-level magnetic suspension bearing driver provided by the present disclosure.

FIG. 3 is a structure diagram of a three-level four-bridge arm driver in an embodiment of a midpoint potential balancing system based on a multi-level magnetic suspension bearing driver provided by the present disclosure.

FIG. 4 is a current loop control block diagram of a three-level four-bridge arm driver in an embodiment of a midpoint potential balancing system based on a multi-level magnetic suspension bearing driver provided by the present disclosure.

FIG. 5 is a structure diagram of a drive circuit and a sampling module in an embodiment of a midpoint potential balancing system based on a multi-level magnetic suspension bearing driver provided by the present disclosure.

FIG. 6 is a schematic flowchart of an embodiment of a midpoint potential balancing method based on a multi-level magnetic suspension bearing driver provided by the present disclosure.

FIG. 7 is a winding current control simulation diagram of an embodiment of a midpoint potential balancing method based on a multi-level magnetic suspension bearing driver provided by the present disclosure.

FIG. 8 is a midpoint potential control simulation diagram of an embodiment of a midpoint potential balancing method based on a multi-level magnetic suspension bearing driver provided by the present disclosure.

### DESCRIPTION OF THE EMBODIMENTS

The technical solutions in the embodiments of the present disclosure will be clearly and completely described below in conjunction with the accompanying drawings in the embodiments of the present disclosure. Clearly, the described embodiments are only a part of the embodiments of the present disclosure, rather than all of the embodiments. Based on the embodiments of the present disclosure, all other embodiments obtained by those skilled in the art without creative efforts fall within the scope to be protected by the present disclosure.

In the description of the embodiments of the present disclosure, unless otherwise specified, "multiple" means two or more. "And/or" describes the association relationship of associated objects, indicating that three relationships may exist, for example: A and/or B may represent: A exists alone, A and B exist simultaneously, and B exists alone.

The descriptions such as "first" and "second" involved in the embodiments of the present disclosure are only for descriptive purposes, and may not be understood as indicating or implying their relative importance or implicitly indicating the number of the indicated technical features. Therefore, the technical features defined with "first" and "second" may explicitly or implicitly include at least one of the features.

The term "embodiment" as used herein signifies that a particular feature, structure, or characteristic described in conjunction with the embodiment may be included in at least one embodiment of the present disclosure. The appearance of this phrase in various locations throughout the specification does not necessarily refer to the same embodiment, nor is it indicative of mutually exclusive independent or alternative embodiments. It is explicitly and implicitly understood by those skilled in the art that the embodiments described herein may be combined with other embodiments.

Before presenting the embodiments, the following terms are explained.

The present disclosure provides a midpoint potential balancing system based on a multi-level magnetic suspension bearing driver, which is described respectively below.

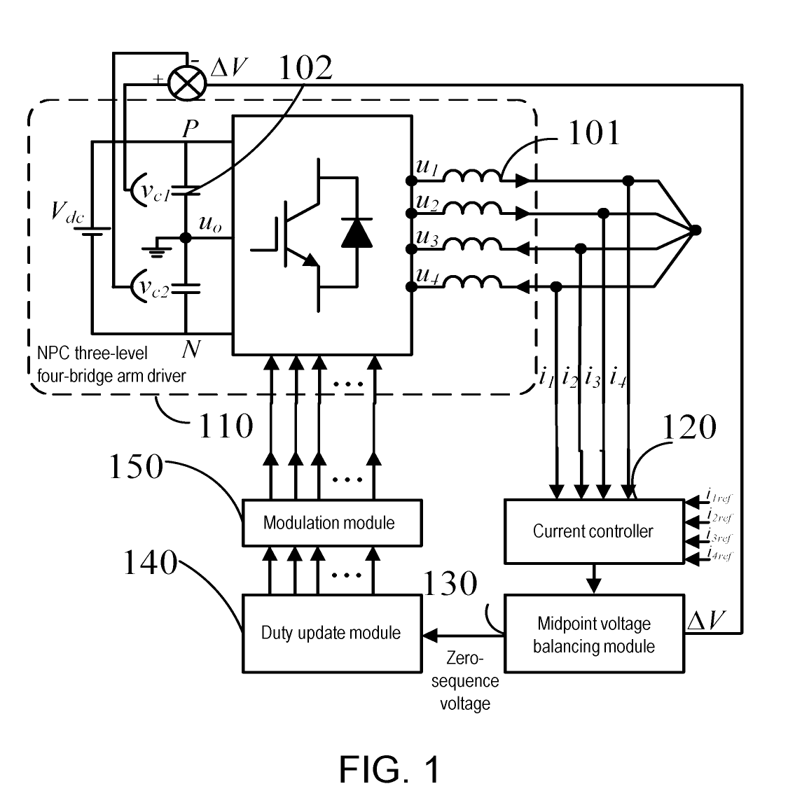

FIG. 1 is a system structure diagram of an embodiment of a midpoint potential balancing system based on a multi-level magnetic suspension bearing driver provided by the present disclosure, including:

A three-level four-bridge arm driver 110 includes a switch bridge arm module 101 and a capacitor bridge arm module 102 connected in parallel, for acquiring winding current sampling data, and regulating a voltage of the switch bridge arm module 101 based on a voltage control signal to balance a midpoint potential of the capacitor bridge arm module 102;

A current controller 120, for receiving the winding current sampling data, and obtaining an average voltage of the switch bridge arm module 101 based on the winding current sampling data;

A midpoint voltage balancing module 130, communicatively connected to the current controller 120, for obtaining a zero-sequence voltage based on the average voltage of the switch bridge arm module 101;

A duty update module 140, communicatively connected to the midpoint voltage balancing module 130, for receiving the zero-sequence voltage and the average voltage of the switch bridge arm module 101, and obtaining a switching time based on the zero-sequence voltage and the average voltage of the switch bridge arm module 101;

A modulation module 150, communicatively connected to the duty update module 140, for receiving the switching time, and obtaining the voltage control signal based on the switching time.

It should be noted that the midpoint potential balancing system based on the multi-level magnetic suspension bearing driver provided by the present disclosure includes the three-level four-bridge arm driver 110, the current controller 120, the midpoint voltage balancing module 130, the duty update module 140, and the modulation module 150, wherein the three-level four-bridge arm driver 110 further includes the switch bridge arm module 101. The present disclosure creatively provides the switch bridge arm module 101 and the capacitor bridge arm module 102, and controls the switch bridge arm module through the voltage control signal generated by the current controller 120, the midpoint voltage balancing module 130, the duty update module 140, and the modulation module 150 to achieve a three-level control effect, thereby being able to increase the number of steps for current conversion, reduce current harmonics, and boost the control on the three-level four-bridge arm driver, so as to achieve the midpoint potential balance of the capacitor bridge arm module 102.

It should be further noted that, in each switch cycle, a sampling unit collects current signals of four windings of the NPC three-level four-bridge arm driver 101 and sends them to the current controller 120, and calculates a midpoint average voltage command of each bridge arm in combination with a reference value. The midpoint voltage balancing module 130 collects the voltage difference between upper and lower capacitors on a DC side and determines the zero-sequence voltage required to be injected together with the winding current and the midpoint average voltage command. The duty update module 140 combines the initially calculated midpoint average voltage command of each bridge arm with the zero-sequence voltage to calculate the switching time, and outputs the modulation signal after the modulation signal is generated by the modulation module 150, and accesses each switch of each bridge arm in the NPC three-level four-bridge arm driver 101 through a drive circuit.

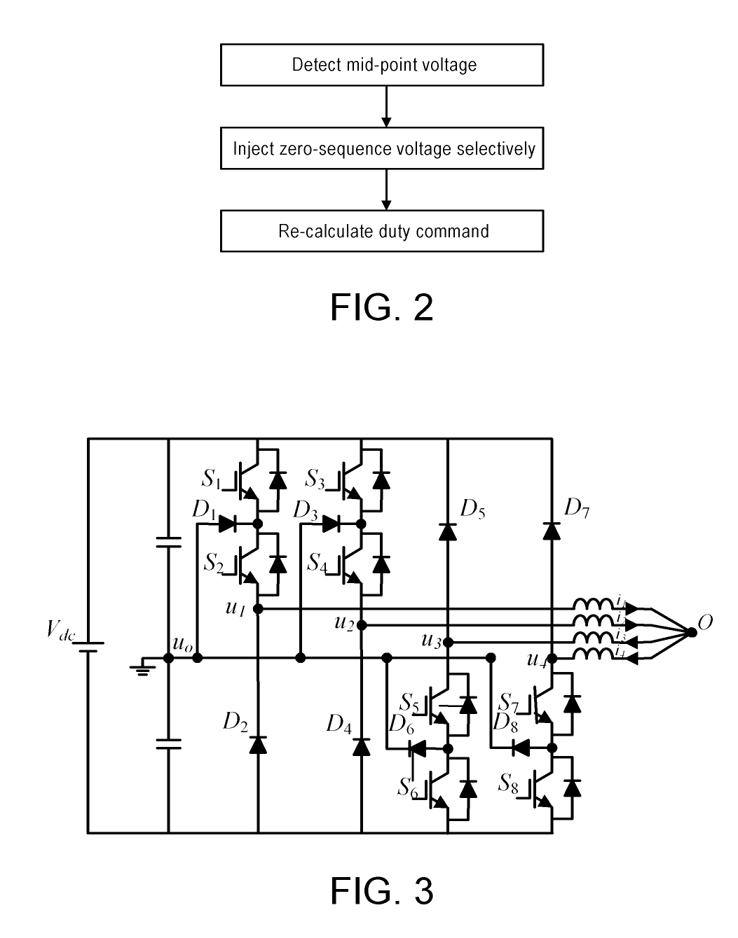

FIG. 2 is a flowchart of a midpoint potential balancing method in an embodiment of the midpoint potential balancing system based on the multi-level magnetic suspension bearing driver provided by the present disclosure, including: four half-bridge arms and four winding units;

A first half-bridge arm is electrically connected to one end of a first winding unit;

A second half-bridge arm is electrically connected to one end of a second winding unit;

A third half-bridge arm is electrically connected to one end of a third winding unit;

A fourth half-bridge arm is electrically connected to one end of a fourth winding unit;

The other end of the first winding unit is electrically connected to the other end of the second winding unit, the other end of the third winding unit, and the other end of the fourth winding unit.

It should be noted that the midpoint potential balancing system based on the multi-level magnetic suspension bearing driver provided by the present disclosure includes the three-level four-bridge arm driver 110, the current controller 120, the midpoint voltage balancing module 130, the duty update module 140, and the modulation module 150, wherein the three-level four-bridge arm driver 110 further includes the switch bridge arm module 101 and the capacitor bridge arm module 102 connected in parallel. The present disclosure creatively provides the switch bridge arm module 101, which achieves the three-level control effect through voltage control signals generated by the current controller 120, the midpoint voltage balancing module 130, the duty update module 140, and the modulation module 150 to control the switch bridge arm module, thereby increasing the number of steps for current conversion, reducing current harmonics, and boosting the control on the three-level four-bridge arm driver, so as to achieve the midpoint potential balance of the capacitor bridge arm module 102.

FIG. 3 is a structure diagram of the three-level four-bridge arm driver 101 in an embodiment of the midpoint potential balancing system based on the multi-level magnetic suspension bearing driver provided by the present disclosure, including:

A first switch device, a first unidirectional conduction device, a second switch device, and a second unidirectional conduction device;

One end of the first switch device is electrically connected to one end of the second switch device and one end of the first unidirectional conduction device;

The other end of the second switch device is electrically connected to one end of the second unidirectional conduction device.

It should be noted that FIG. 3 shows an NPC three-level four-bridge arm topology structure. The capacitor bridge arm includes two capacitors connected in series, with both ends connected to positive and negative ends of a DC power supply respectively, and a midpoint of the two capacitors serves as a midpoint level terminal. Additionally, 4 half-bridge arms are further included, with the midpoint of each bridge arm connected to one end of a winding, and the other ends of all windings connected to a common node O. Four winding currents i₁, i₂, i₃, and i₄ respectively generate electromagnetic forces in two degrees of freedom directions of the magnetic suspension bearing. i₁ and i₂ control one degree of freedom, and i₃ and i₄ control another degree of freedom, wherein i₁+i₂=i₃+i₄=2I_{bias}, and I_{bias} is a magnetic suspension bearing bias current which is a constant value.

Preferably, i₁ and i₂ are arranged to flow out of the three-level bridge arm, and i₃ and i₄ are arranged to flow into the three-level bridge arm, so that the currents flowing into and out of the common node O are the same.

Preferably, when the winding current flows out of the bridge arm midpoint, a first end of the first switch device is connected to a first end of the upper capacitor, a second end of the first switch device is connected to a first end of the second switch device and a first end of the first unidirectional conduction device, a second end of the second switch device is connected to a first end of the second unidirectional conduction device and serves as the bridge arm midpoint to connect to the winding, a second end of the second unidirectional conduction device is connected to a second end of the lower capacitor, and the second end of the first unidirectional conduction device is connected to the midpoint level terminal. When the winding current flows into the bridge arm midpoint, the first end of the first unidirectional conduction device is connected to the first end of the upper capacitor, the second end of the first unidirectional conduction device is connected to the first end of the first switch device and serves as the bridge arm midpoint to connect to the winding, the second end of the first switch device is connected to the first end of the second switch device and the second end of the second unidirectional conduction device, the second end of the second switch device is connected to the second end of the lower capacitor, and the first end of the second unidirectional conduction device is connected to the midpoint level terminal.

In some embodiments of the present disclosure, the second half-bridge arm includes: a third switch device, a third unidirectional conduction device, a fourth switch device, and a fourth unidirectional conduction device;

One end of the third switch device is electrically connected to one end of the fourth switch device and one end of the third unidirectional conduction device;

The other end of the fourth switch device is electrically connected to one end of the fourth unidirectional conduction device.

It should be noted that the present disclosure provides the midpoint potential balancing system based on the multi-level magnetic suspension bearing driver. The system includes the three-level four-bridge arm driver 110, the current controller 120, the midpoint voltage balancing module 130, the duty update module 140, and the modulation module 150, wherein the three-level four-bridge arm driver 110 further includes the switch bridge arm module 101 and the capacitor bridge arm module 102. The present disclosure creatively provides the switch bridge arm module 101, which achieves the three-level control effect through the voltage control signals generated by the current controller 120, the midpoint voltage balancing module 130, the duty update module 140, and the modulation module 150 to control the switch bridge arm module, thereby increasing the number of steps for current conversion, reducing current harmonics, and boosting the control on the three-level four-bridge arm driver, so as to achieve the midpoint potential balance of the capacitor bridge arm module 102.

In some embodiments of the present disclosure, the third half-bridge arm includes: a fifth switch device, a fifth unidirectional conduction device, a sixth switch device, and a sixth unidirectional conduction device;

One end of the fifth unidirectional conduction device is electrically connected to one end of the fifth switch device;

The other end of the fifth switch device is electrically connected to one end of the sixth switch device and one end of the sixth unidirectional conduction device.

It should be noted that the present disclosure provides the midpoint potential balancing system based on the multi-level magnetic suspension bearing driver. The system includes the three-level four-bridge arm driver 110, the current controller 120, the midpoint voltage balancing module 130, the duty update module 140, and the modulation module 150, wherein the three-level four-bridge arm driver 110 further includes the switch bridge arm module 101 and the capacitor bridge arm module 102. The present disclosure creatively provides the switch bridge arm module 101, which achieves the three-level control effect through voltage control signals generated by the current controller 120, the midpoint voltage balancing module 130, the duty update module 140, and the modulation module 150 to control the switch bridge arm module, thereby increasing the number of steps for current conversion, reducing current harmonics, and boosting the control on the three-level four-bridge arm driver, so as to achieve the midpoint potential balance of the capacitor bridge arm module 102.

In some embodiments of the present disclosure, the fourth half-bridge arm includes: a seventh switch device, a seventh unidirectional conduction device, an eighth switch device, and an eighth unidirectional conduction device;

One end of the seventh unidirectional conduction device is electrically connected to one end of the seventh switch device;

The other end of the seventh switch device is electrically connected to one end of the eighth switch device and one end of the eighth unidirectional conduction device.

It should be noted that the present disclosure provides the midpoint potential balancing system based on the multi-level magnetic suspension bearing driver. The system includes the three-level four-bridge arm driver 110, the current controller 120, the midpoint voltage balancing module 130, the duty update module 140, and the modulation module 150, wherein the three-level four-bridge arm driver 110 further includes the switch bridge arm module 101 and the capacitor bridge arm module 102. The present disclosure creatively provides the switch bridge arm module 101, which achieves the three-level control effect through the voltage control signals generated by the current controller 120, the midpoint voltage balancing module 130, the duty update module 140, and the modulation module 150 to control the switch bridge arm module, thereby increasing the number of steps for current conversion, reducing current harmonics, and boosting the control on the three-level four-bridge arm driver, so as to achieve the midpoint potential balance of the capacitor bridge arm module 102.

In some embodiments of the present disclosure, the three-level four-bridge arm driver 110 includes: the capacitor bridge arm module, wherein the capacitor bridge arm module is connected in parallel with the switch bridge arm module 101;

The capacitor bridge arm module includes: a first capacitor and a second capacitor;

One end of the first capacitor is electrically connected to the first switch device, the third switch device, the fifth unidirectional conduction device, and the seventh unidirectional conduction device. The other end of the first capacitor is electrically connected to one end of the second capacitor, the other end of the first unidirectional conduction device, the other end of the third unidirectional conduction device, the other end of the sixth unidirectional conduction device, and the other end of the eighth unidirectional conduction device. The other end of the second capacitor is electrically connected to the other end of the second unidirectional conduction device, the other end of the fourth unidirectional conduction device, the other end of the sixth switch device, and the other end of the eighth switch device.

It should be noted that the present disclosure provides the midpoint potential balancing system based on the multi-level magnetic suspension bearing driver. The system includes the three-level four-bridge arm driver 110, the current controller 120, the midpoint voltage balancing module 130, the duty update module 140, and the modulation module 150, wherein the three-level four-bridge arm driver 110 further includes the switch bridge arm module 101 and the capacitor bridge arm module. The present disclosure creatively provides the switch bridge arm module 101, which achieves the three-level control effect through the voltage control signals generated by the current controller 120, the midpoint voltage balancing module 130, the duty update module 140, and the modulation module 150 to control the switch bridge arm module, thereby increasing the number of steps for current conversion, reducing current harmonics, and boosting the control on the three-level four-bridge arm driver, so as to achieve the midpoint potential balance of the capacitor bridge arm module 102.

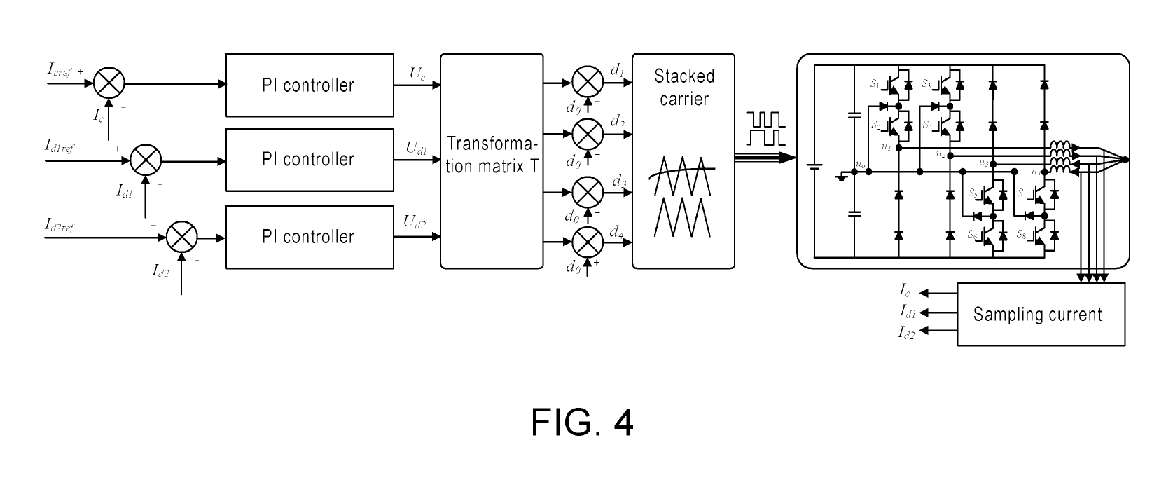

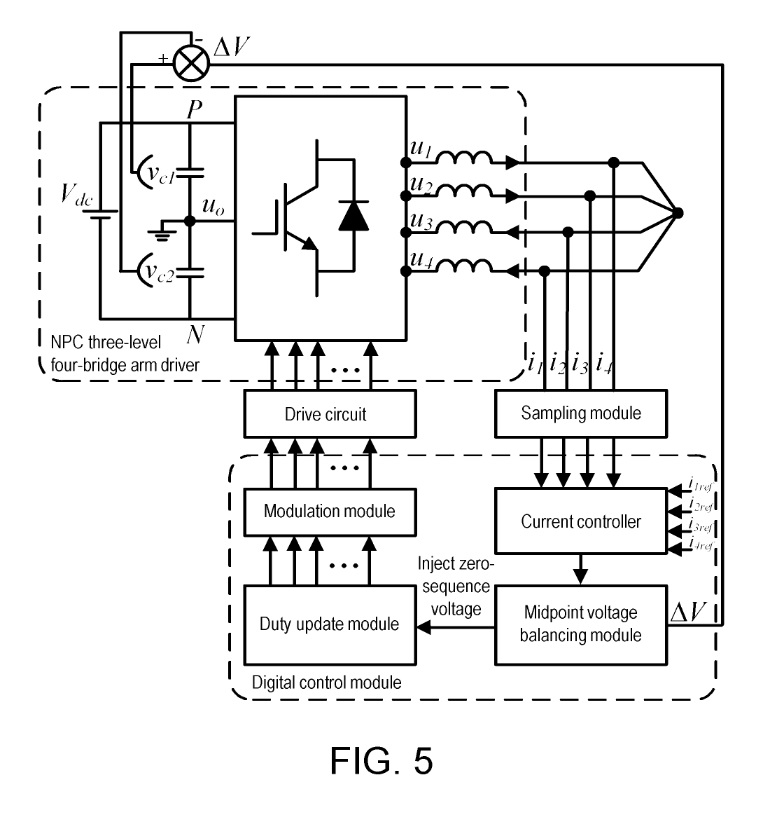

FIG. 4 is a current loop control block diagram of the three-level four-bridge arm driver 101 in an embodiment of the midpoint potential balancing system based on the multi-level magnetic suspension bearing driver provided by the present disclosure. FIG. 5 is a structure diagram of the drive circuit and a sampling module in an embodiment of the midpoint potential balancing system based on the multi-level magnetic suspension bearing driver provided by the present disclosure, including:

A sampling module, communicatively connected to the three-level four-bridge arm driver 110, for acquiring the winding current sampling data.

It should be noted that four winding currents are sampled, and a common-mode current I_{c}=i₁+i₂=i₃+i₄and a differential-mode current I_{d1}=i₁-i₂, I_{d2}=i₃-i₄ are calculated. These are fed back to the current controller for comparison with reference values.

Preferably, the current controller adopts a PI controller for regulation, given a common-mode voltage U_{c}=(u₁+u₂-u₃-u₄)/2 and a differential-mode voltage command U_{d1}=u₁-u₂ and U_{d2}=u₄-u₃, and these are converted through a transformation matrix T into the average voltage command for each bridge arm, wherein u₁, u₂, u₃, and u₄are the average midpoint voltage commands of the four switch bridge arms.

Preferably, the transformation matrix T may be obtained according to a relationship between the common-mode voltage and the bridge arm average midpoint voltage.

The average midpoint voltage is added to the injected zero-sequence voltage d₀ to obtain a final duty command, which drives switch devices after carrier modulation.

Preferably, when a voltage difference between the upper capacitor and the lower capacitor is greater than zero, the zero-sequence voltage d₀ has a value in a range of (0, dmax). When a voltage difference between the upper capacitor and the lower capacitor is less than zero, the zero-sequence voltage d₀ has a value in a range of (-dmax, 0); dmax is a maximum duty command without overmodulation.

In some embodiments of the present disclosure, the system further includes: the drive circuit, electrically connected to the modulation module 150, for receiving the voltage control signals generated by the modulation module 150, and generating a drive signal based on the voltage control signal.

The three-level four-bridge-arm driver 110 is further electrically connected to the drive circuit, for receiving the drive signal, and regulating a voltage of the switch bridge arm module 101 based on the drive signal to balance a midpoint potential of a driver.

It may be understood that the present disclosure adopts 8 controllable switch devices to achieve the control of two-degree-of-freedom magnetic suspension bearing winding current, and is able to achieve the three-level control effect, which may increase the number of steps for current conversion in the winding current control process, reduce current harmonics, boost the winding current control quality, and boost electromagnetic compatibility.

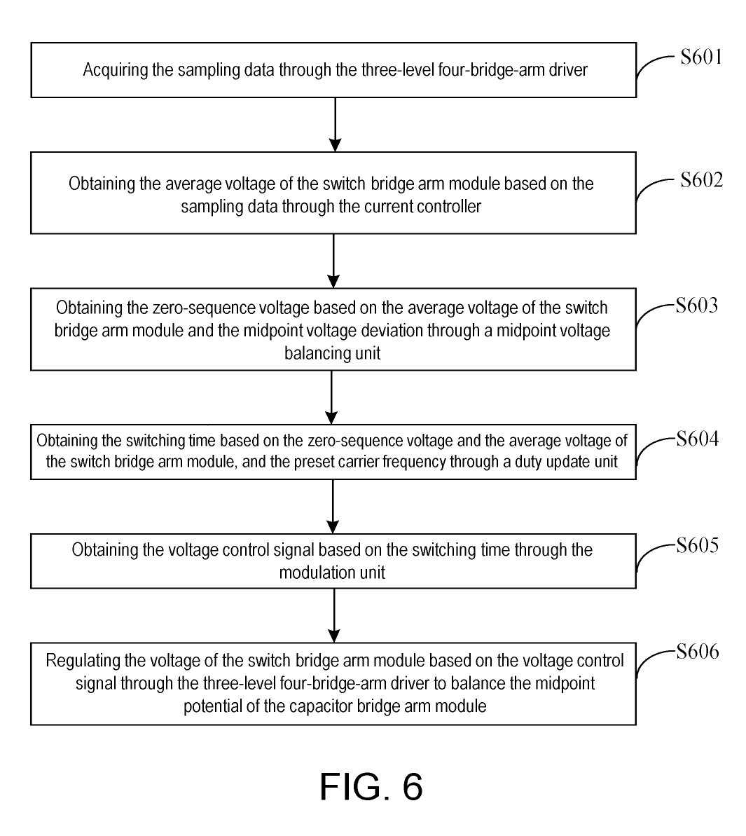

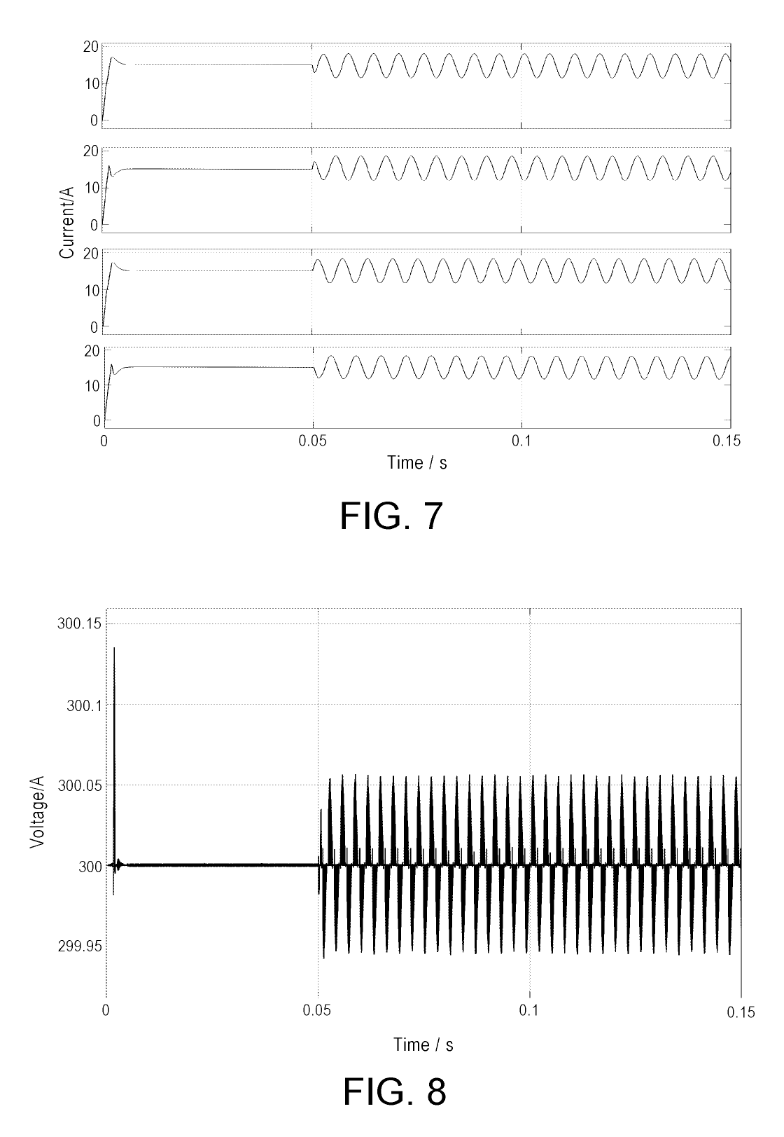

FIG. 6 is a schematic flowchart of an embodiment of the midpoint potential balancing method based on the multi-level magnetic suspension bearing driver provided by the present disclosure. FIG. 7 is a winding current control simulation diagram of an embodiment of the midpoint potential balancing method based on the multi-level magnetic suspension bearing driver provided by the present disclosure. FIG. 8 is a midpoint potential control simulation diagram of an embodiment of the midpoint potential balancing method based on the multi-level magnetic suspension bearing driver provided by the present disclosure, including:

S601, acquiring the winding current sampling data through the three-level four-bridge-arm driver;

S602, obtaining the average voltage of the switch bridge arm module based on the winding current sampling data through the current controller;

S603, obtaining the zero-sequence voltage based on the average voltage of the switch bridge arm module and the midpoint voltage deviation through a midpoint voltage balancing unit;

S604, obtaining the switching time based on the zero-sequence voltage and the average voltage of the switch bridge arm module, and the preset carrier frequency through a duty update unit;

S605, obtaining the voltage control signal based on the switching time through the modulation unit;

S606, regulating the voltage of the switch bridge arm module based on the voltage control signal through the three-level four-bridge-arm driver to balance the midpoint potential of the capacitor bridge arm module.

The midpoint potential balancing system based on the multi-level magnetic suspension bearing driver provided by the present disclosure has been described in detail above. In the present disclosure, specific examples have been applied to illustrate the principle and implementation of the present disclosure. The description of the above embodiments is only used to help understand the method and core idea of the present disclosure. Meanwhile, for those skilled in the art, according to the idea of the present disclosure, there may be changes in the specific implementation and application scope. In summary, the content of this specification should not be construed as a limitation to the present disclosure.

What is claimed is:

1. A midpoint potential balancing system based on a multi-level magnetic suspension bearing driver, comprising:
a three-level four-bridge arm driver, comprising a switch bridge arm module and a capacitor bridge arm connected in parallel, and provided to acquire winding current sampling data, and regulate a voltage of the switch bridge arm module based on a voltage control signal to balance a midpoint potential of the capacitor bridge arm module;
a current controller, configured to receive the winding current sampling data, and obtain an average voltage of the switch bridge arm module based on the winding current sampling data;
a midpoint voltage balancing unit, communicatively connected to the current controller, and configured to obtain a zero-sequence voltage based on the average voltage of the switch bridge arm module;
a duty update unit, communicatively connected to the midpoint voltage balancing unit, and configured to receive the zero-sequence voltage and the average voltage of the switch bridge arm module, and obtain a switching time based on the zero-sequence voltage and the average voltage of the switch bridge arm module;
a modulation unit, communicatively connected to the duty update unit, and configured to receive the switching time, and obtain the voltage control signal based on the switching time.

2. The midpoint potential balancing system based on the multi-level magnetic suspension bearing driver according to claim 1, wherein the switch bridge arm module comprises: four half-bridge arms and four winding units;
a first half-bridge arm is electrically connected to one end of a first winding unit;
a second half-bridge arm is electrically connected to one end of a second winding unit;
a third half-bridge arm is electrically connected to one end of a third winding unit;
a fourth half-bridge arm is electrically connected to one end of a fourth winding unit;
the other end of the first winding unit is electrically connected to the other end of the second winding unit, the other end of the third winding unit, and the other end of the fourth winding unit.

3. The midpoint potential balancing system based on the multi-level magnetic suspension bearing driver according to claim 2, wherein the first half-bridge arm comprises: a first switch device, a first unidirectional conduction device, a second switch device, and a second unidirectional conduction device;
one end of the first switch device is electrically connected to one end of the second switch device and one end of the first unidirectional conduction device;
the other end of the second switch device is electrically connected to one end of the second unidirectional conduction device.

4. The midpoint potential balancing system based on the multi-level magnetic suspension bearing driver according to claim 2, wherein the second half-bridge arm comprises: a third switch device, a third unidirectional conduction device, a fourth switch device, and a fourth unidirectional conduction device;
one end of the third switch device is electrically connected to one end of the fourth switch device and one end of the third unidirectional conduction device;
the other end of the fourth switch device is electrically connected to one end of the fourth unidirectional conduction device.

5. The midpoint potential balancing system based on the multi-level magnetic suspension bearing driver according to claim 2, wherein the third half-bridge arm comprises: a fifth switch device, a fifth unidirectional conduction device, a sixth switch device, and a sixth unidirectional conduction device;
one end of the fifth unidirectional conduction device is electrically connected to one end of the fifth switch device;
the other end of the fifth switch device is electrically connected to one end of the sixth switch device and one end of the sixth unidirectional conduction device.

6. The midpoint potential balancing system based on the multi-level magnetic suspension bearing driver according to claim 2, wherein the fourth half-bridge arm comprises: a seventh switch device, a seventh unidirectional conduction device, an eighth switch device, and an eighth unidirectional conduction device;
one end of the seventh unidirectional conduction device is electrically connected to one end of the seventh switch device;
the other end of the seventh switch device is electrically connected to one end of the eighth switch device and one end of the eighth unidirectional conduction device.

7. The midpoint potential balancing system based on the multi-level magnetic suspension bearing driver according to claim 1, wherein the capacitor bridge arm module comprises: a first capacitor and a second capacitor;
one end of the first capacitor is electrically connected to a first switch device, a third switch device, a fifth unidirectional conduction device, and a seventh unidirectional conduction device, the other end of the first capacitor is electrically connected to one end of the second capacitor, another end of a first unidirectional conduction device, another end of a third unidirectional conduction device, another end of a sixth unidirectional conduction device, and another end of an eighth unidirectional conduction device, and the other end of the second capacitor is electrically connected to another end of a second unidirectional conduction device, another end of a fourth unidirectional conduction device, another end of a sixth switch device, and another end of an eighth switch device.

8. The midpoint potential balancing system based on the multi-level magnetic suspension bearing driver according to claim 1, wherein the system further comprises a sampling module, communicatively connected to the three-level four-bridge arm driver, for acquiring the winding current sampling data.

9. The midpoint potential balancing system based on the multi-level magnetic suspension bearing driver according to claim 8, wherein the system further comprises: a drive circuit, electrically connected to the modulation unit, for receiving the voltage control signal generated by the modulation unit, and generating a drive signal based on the voltage control signal;
the three-level four-bridge arm driver is further electrically connected to the drive circuit, for receiving the drive signal, and regulating the voltage of the switch bridge arm module based on the drive signal to balance a midpoint potential of a driver.

10. A midpoint potential balancing method based on a multi-level magnetic suspension bearing driver, and based on the midpoint potential balancing system based on the multi-level magnetic suspension bearing driver according to claim 1, the method comprising:
acquiring the winding current sampling data through the three-level four-bridge arm driver;
obtaining the average voltage of the switch bridge arm module based on the winding current sampling data through the current controller;
obtaining the zero-sequence voltage based on the average voltage of the switch bridge arm module and a midpoint voltage deviation of the capacitor bridge arm module through the midpoint voltage balancing unit;
obtaining the switching time based on the zero-sequence voltage and the average voltage of the switch bridge arm module through the duty update unit;
obtaining the voltage control signal based on the switching time through the modulation unit;
regulating the voltage of the switch bridge arm module based on the voltage control signal through the three-level four-bridge arm driver to balance the midpoint potential of the capacitor bridge arm module.
